(19) United States
(12) Patent Application Publication
(10) Pub. No.: US 2012/0208489 A1
(43) Pub. Date: Aug. 16, 2012

(54) Personal Security With Location Tracking Service

(76) Inventor: Majd Jadaan, Las Vegas, NV (US)

(21) Appl. No.: 13/024,639

(22) Filed: Feb. 10, 2011

(51) Int. Cl. H04W 4/22

(52) U.S. Cl. 455/404.2

(57) ABSTRACT

The present invention relates generally to personal security, and more particularly to a personal security system and method, which utilizes global positioning system (GPS) and cellular networks of mobile phones to send out an alert with personal and location information to the assistance providers that agree to provide immediate services. The personal security system comprises a location tracking system to track the location of the mobile phone and a software program that displays assistance provider icons on the mobile phone's touch screen for the user to select the different assistance by touching the icon. The software program may utilize the button on the mobile phone such as having the fast dial or side button programmed to request different services. The assistance providers may include police station, medical center, fire department, roadside service, etc. Other types of communication technologies and location tracking systems known in the art may be used.

### BACKGROUND OF THE INVENTION

1. Field of the Invention

The present invention relates generally to personal security, and more particularly to a personal security system and method, which utilizes land lines where the customer dials a specific number that connects the customer through the provider to the personal security service or which utilizes global positioning system (GPS) and cellular networks of mobile phone to send out an alert with personal and location information to the assistance providers that agree to provide immediate services.

2. Description of Related Art

In today's world, people are vulnerable to every day emergency and terrorist attacks such as child kidnapping, medical emergencies, personal attacks, injuries, theft, gang fights, gun shootings, terrorist's attacks, car stealing, car accidents in isolated areas, lost elderly people, lost or badly injured soldiers etc. When a 911 call or a hospital call is made for help, it may be put on hold or switched to other units for more questions while a person is not in a position to wait or answer to any questions. Sometimes, when a person is surrounded by a gang and their life is threatened, they may not have the chance to call, speak or scream for help. When a person is caught in a terrorist attack, hijack and is being closely watched by the terrorists or hijackers, they will also not have the chance to call 911 or speak. Another scenario is when a person is in a serious medical emergency, they may not have the strength to call 911 or the hospital and answer questions. There are also cases of when a person has their car break down in an isolated area and have no idea about their location. Or when a person is lost in other countries and cannot speak the language, they will not be able to describe their location and get help/assistance.

Mobile phones play a critical role in the daily life of modern society. People carry mobile phones all the time. In US, 91% of the population has a mobile phone. Therefore, it is highly likely that when a person faces an emergency and needs help, he will have a mobile phone with him. Since FCC enhanced 911 protocol, FCC has been requiring all the mobile phone manufactures in the US to include GPS receivers even if the phones do not have turn-by-turn direction capability; the goal is to allow 911 to locate the location of all the calls made to 911 from mobile phones like current calls made through landlines.

The invention presented in this application is a personal security system and a method that gives people access to assistance through a press of a button. The present invention utilizes global positioning system (GPS) and cellular network of mobile phones to locate the whereabouts of the person who sends out the emergency/assistance alert along with their personal information to the assistance providers that agreed to dispatch immediate assistance. The present invention allows the users to have direct interaction with the assistance providers thus reducing the time spent on the process. The present invention may have the function to acknowledge the receipt of assistance request and provide dispatch update to the user to relieve the stress of the user.

Numerous tracking and location systems that utilizes GPS have been provided in the prior art. For example, U.S. Pat. Nos. 5,905,461; 6,362,778; 6388612; 7,248,170; 7,242,322; and U.S. Pre-Grant publications 2008/0231499; 2009/0289785; and 2010/0022255. These patents do not involve dispatch of assistances and they lack a fast and responsive system for summoning assistance that a person at risk needs.

U.S. Pat. No. 6,624,754 to Hoffman discloses a personal security and tracking system. The system enables an individual in distress to initiate an alarm to alert appropriate personnel combined with a locating and tracking system that enables the alerted personnel to monitor the location of the individual. The system comprises a portable signaling unit including a location system and a manual trigger switch to provide the priority alarm levels. It relies on a central processing station to interpret the priority alarm levels and dispatch appropriate emergency assistance to the location of the individual in response to the alarm levels. The process involves more steps and parties so it takes longer than a direct interaction between the individual and the emergency assistance providers.

The invention disclosed in the present application provides separate buttons or icons relating to different emergency/assistance needs, such as a separate button for police stations, a separate button for hospitals, a separate button for road services, etc. A push of a button (or icon) connects the person in distress/need with the right assistance providers without going through a central processing station; thus, the system is more efficient. The present invention may further have the function to acknowledge the receipt of assistance request and provide dispatch update to the user to relieve the stress of the user. The personal security system is like a VIP 24 hour's security but guarantees privacy because the GPS only reveals the location of the user when the user presses the alert button. In addition to police and medical assistance, the present invention aims to provide one-icon-touch access to roadside services and taxi services worldwide.

In another embodiment of the invention the user dials a specific number on his/her land lines phone that connects the customer through the provider to the personal security service. With this embodiment the GPS service does not have to be activated.

### SUMMARY OF THE INVENTION

The object of the present invention is to provide a personal security system and method wherein the user is able to send an SMS or email alert, via the push of a button or touch of an icon, to the assistance providers including but not limited to police stations or medical facilities using their mobile phones containing a GPS receiver.

Another object of the present invention is to provide means for the assistance providers to locate and track the person who sends out an alert signal.

Yet another object is to utilize the GPS receiver in the user's mobile phone to communicate with the GPS satellite and relay the location determined by the GPS satellite ultimately to an assistance provider via the cellular network. Other communication technologies and location tracking technologies may be used for the same purpose.

Still another object of the present invention is to establish committed resources that agree to dispatch immediate assistance to help the user who sends out the alert signal.

Yet another object is to let the user have direct interaction with the assistance providers without going through a central processing station to enhance the efficiency.

Yet a further object of the present invention is to provide the user confirmation that the request is received and the dispatch is on the way in order to relieve the user's stress.

The ultimate object of the present invention is to help the user out of the distressed situation. The service should be available where ever the mobile phones, the GPS coverage, the internet (wireless network) services are available on earth, in the sea, and in the sky. (Cellular phone companies are in the process of developing equipment that can handle calls from the sky.)

The core part of the personal security service according to the present invention involves software which needs to be programmed to be compatible with most of the mobile phones. It can be programmed to present assistance icons on the touch screen, which serves as touch-button for the user to select different assistances. Or it can be so it can utilize the buttons on the hardware (e.g. mobile phones) such as having the fast dial or side button programmed to request different assistances.

The user can download the software after subscribing to the personal security service plan. The software provides multiple options of assistance through selectable icons on the touch screen of the mobile phone or buttons on the mobile phone; the options include but are not limited to police stations, medical facilities, roadside assistance, etc. The software can utilize the GPS receiver in the mobile phone that sends tracking signals. When an individual is in need of assistance, the individual presses the button to send out an alert to the assistance providers via SMS or e-mail alert or other technologies currently known or available in the future. The information regarding the mobile phone owner such as name, age, social security number, driver license number, medical history etc may be provided to the assistance provider depending on the nature of the assistance. For example, if a police station is contacted, more detail information will be provided to the police station. If a medical assistance is needed, the owner's medical history may be provided. If the road service is needed, there's no need to provide social security number. The alert will also contain the time and date.

In the normal mode of operation, a GPS receiver of the mobile phone for communicating with the GPS satellite is normally disabled and the cellular system for communicating is placed in listening mode to conserve the battery. The software is programmed such that when the button is pushed the GPS receiver is enabled in the mobile phone to start communicate with the GPS satellite system. The current location and continuously updated location can be tracked and provided to the assistance providers and/or personal security service.

This software can be distributed all over the world to be used with any kind of mobiles with GPS receivers and to offer the services wherever authorities want to adopt it.

The GPS receiver in the mobile phone tracks mobile phone's position information from GPS satellites. The detected information is then provided to the phone module. When the assistance button is pushed or icon is touched, the phone module collects the location information from the GPS receiver and sends it through cellular networks to assistance providers that can plug the coordinates into map files in their computer system.

Mobile phone makers can choose to add indicator lights on the mobile phones for this service. The software can be programmed to send back responses in text format or through indicator lights to acknowledge that the request is received and assistance has been dispatched. For example, when the request is received the indicator lights are dimmed yellow. When the assistance has been dispatched, the indicator lights are changed to dimmed green. This is for the situation that the user may be kidnapped or attacked by the terrorists and is unable to read the text. This way the user feels reassurance even without talking to the assistance provider. The user can also choose to turn off the indicator lights for security concerns if under close watch by the terrorists. If the situation allows, the user can choose to talk over the phone with the assistance provider. Such situation includes medical emergency and roadside services.

To provide successful personal security service, one paramount factor is to have committed units that sign on agreements to provide immediate assistance once they receive the email or SMS without putting user of the service on hold. The users have direct interaction with the assistance providers without going through a central processing station to enhance the efficiency. The assistance providers are aware of the emergency nature of the service request and do not need to have a conversation with the service requestor before sending out dispatch. Other services functions in a similar fashion. There could be an option of a personal security process center that monitors or records the process or coordinates the dispatch if necessary.

To ensure the personal security service is working properly and necessary assistance is delivered, a fault-penalty, fraud-penalty will be charged for false or fraud request of assistance.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a perspective view of a mobile phone showing the personal security service icons on the touch screen of the mobile phone.

FIG. 2 is a flow chart showing the operation of one embodiment involving coordinates being sent directly to assistance providers according to the present invention.

FIG. 3 is a flow chart showing the operation of another embodiment involving coordinates being sent directly to assistance providers according to the present invention.

FIG. 4 is a flow chart showing the operation of another embodiment involving a personal security process center monitoring the interaction between the user and the assistance providers according to the present invention.

FIG. 5 is a flow chart showing the operation of another embodiment involving a personal security process center in charge of dispatching assistance according to the present invention.

### DESCRIPTION OF THE PREFERRED EMBODIMENT

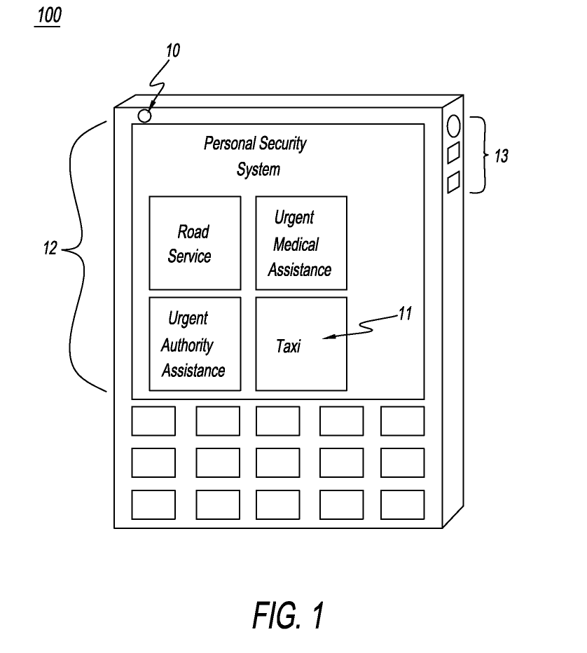

FIG. 1 depicts an embodiment of a personal security system 1000 that includes a mobile phone with a GPS module and software 100 that is programmed to be compatible with most of the mobile phones. It can be programmed to show assistance icons 11 on the screen 12, which serves as touch-button for the user to choose different assistances. Or it can be programmed to interact with the software of the mobile phone, so it can utilize the buttons 13 on the hardware (that is mobile phone) such as having the fast dial or side buttons 13 programmed to request different assistances. Mobile phone makers can choose to add indicator lights 10 on the mobile phone for this service.

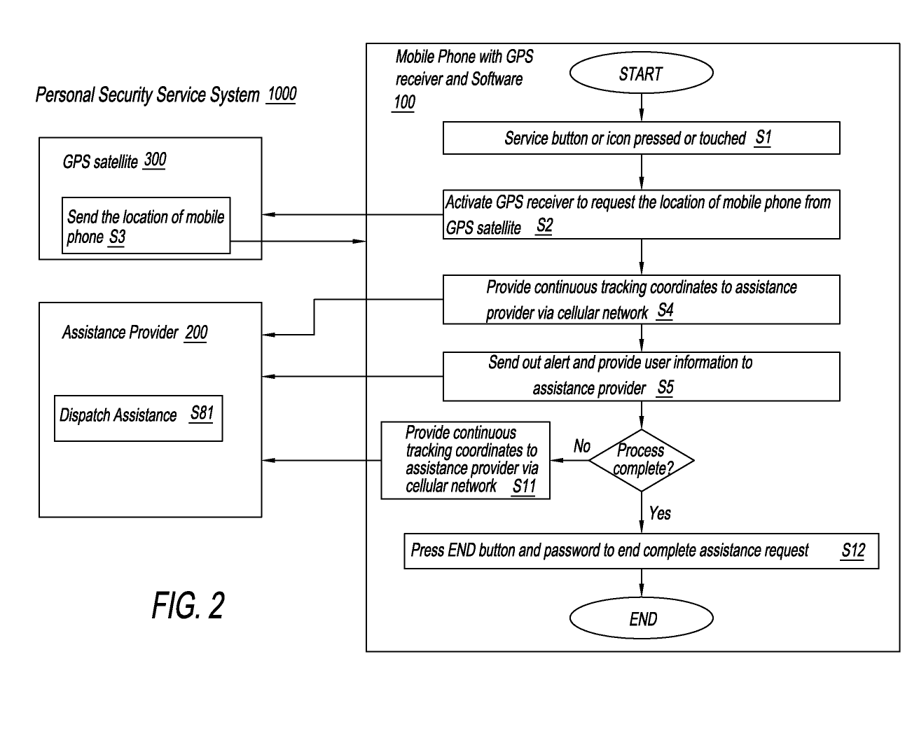

As disclosed in FIG. 2, in order for the personal security service 1000 to work, the system must include an agreed plan from emergency/assistance providers 200. The personal security service utilizes the existing GPS and cellular network technologies including GPS satellite systems 300 and base stations 400.

When an individual is in need of assistance, the individual presses the button or on screen icon on the mobile phone at step S1. The button turns on/activates the GPS receiver in the mobile phone to track the location of the mobile phone from the GPS satellite 300 at step S2. The GPS satellite 300 then sends the location of the mobile phone to the GPS receiver in the mobile phone 100 at step S3. The GPS receiver provides the detected location information to the phone module and the mobile phone provides the location information to the assistance providers 200 at step S4 via the cellular network. The current position's latitude, longitude and altitude can be calculated by the GPS receiver and sent to assistance providers that plug this raw data into map files stored in memory. In the meantime at step S5, the mobile phone 100 sends out an alert to the assistance providers 200 via SMS or e-mail alert. The information regarding the mobile phone owner such as name, age, social security no., driver license no., medical history etc. may be provided to the assistance providers depending on the nature of the assistance. For example, if a police station is contacted, more detail information will be provided to the police station. If a medical assistance is needed, the owner's medical history may be provided. If the road service is needed, there's no need to provide social security number. The software will be programmed to distinguish the nature of the assistance and necessary personal information associated to the assistance.

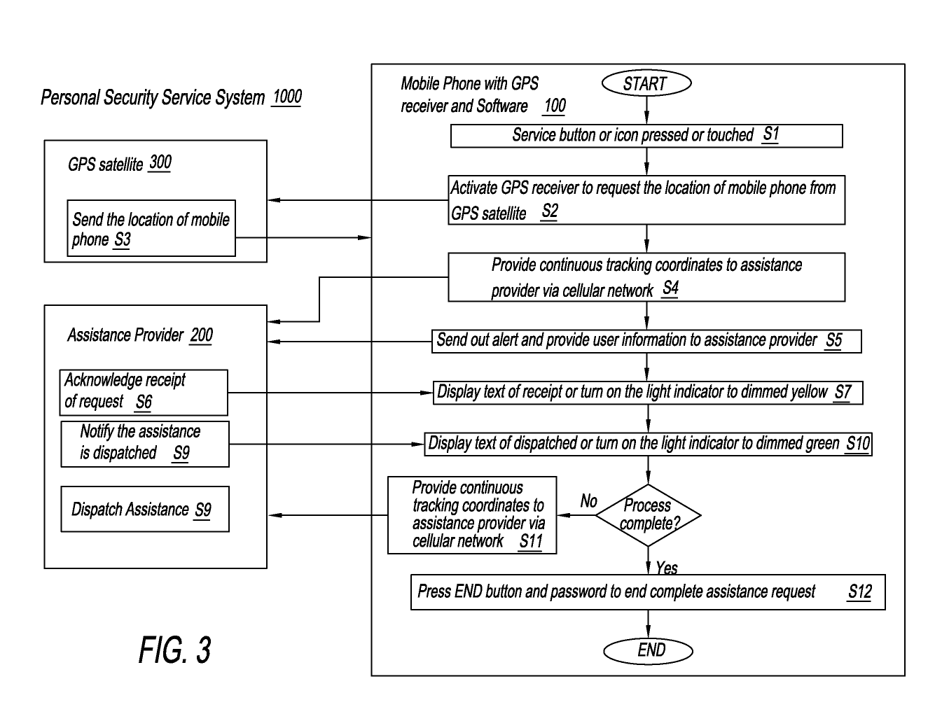

In another embodiment as disclosed in FIG. 3, the software can be programmed to send back responses in text format or through a light indicator to acknowledge that the request is received (step S6). The software can also be programmed to let the assistance providers send updates (step S9) to the user after the assistance is dispatched (step S8) in text format or through a light indicator. For example, when the request is received the light is dimmed yellow (step S7). When the assistance has been dispatched, the light is changed to dimmed green (step S10). This is for the situation that the user may be kidnapped or attacked by the terrorists and is unable to read the text. So the users feel safe even without talking to the assistance provider. The user can also choose to turn off the light for security concerns if the user is under close surveillance by the terrorists. If the situation is allowed, the user can choose to talk over the phone with the assistance provider. Such situation includes but is not limited to medical emergency and road services.

The GPS receiver will continue to provide the location of the mobile phone 100 from the GPS satellite 300 and provides the location information to the assistance provider 200 (step S11) until a “END” button is pressed and a password is entered (step S12).

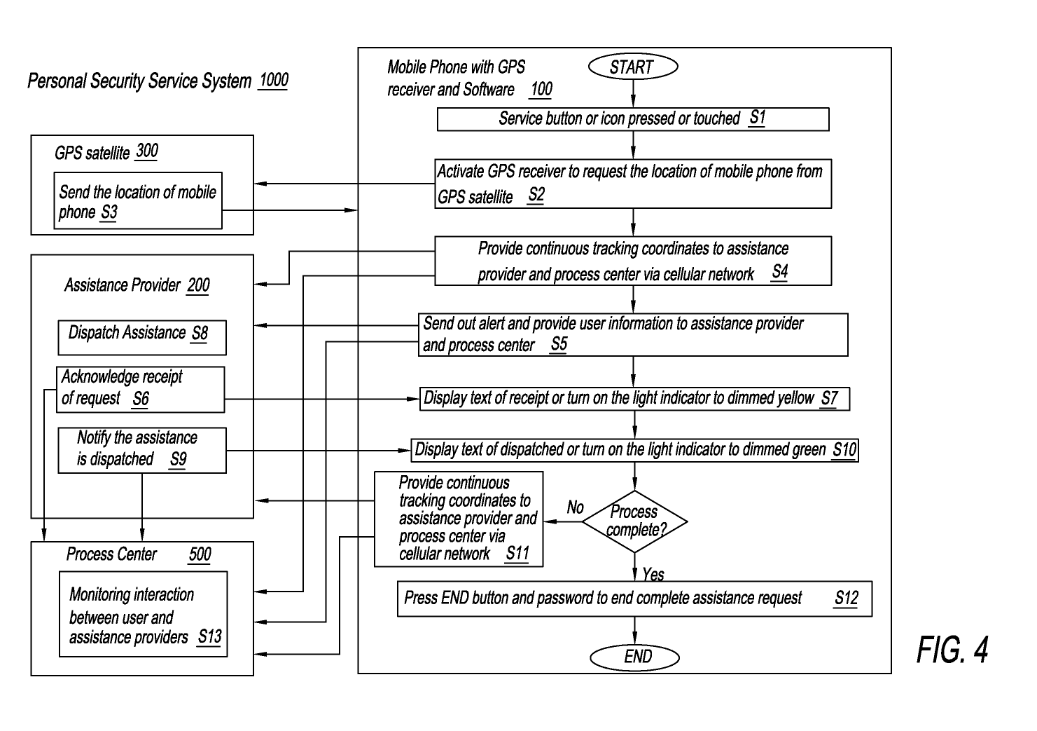

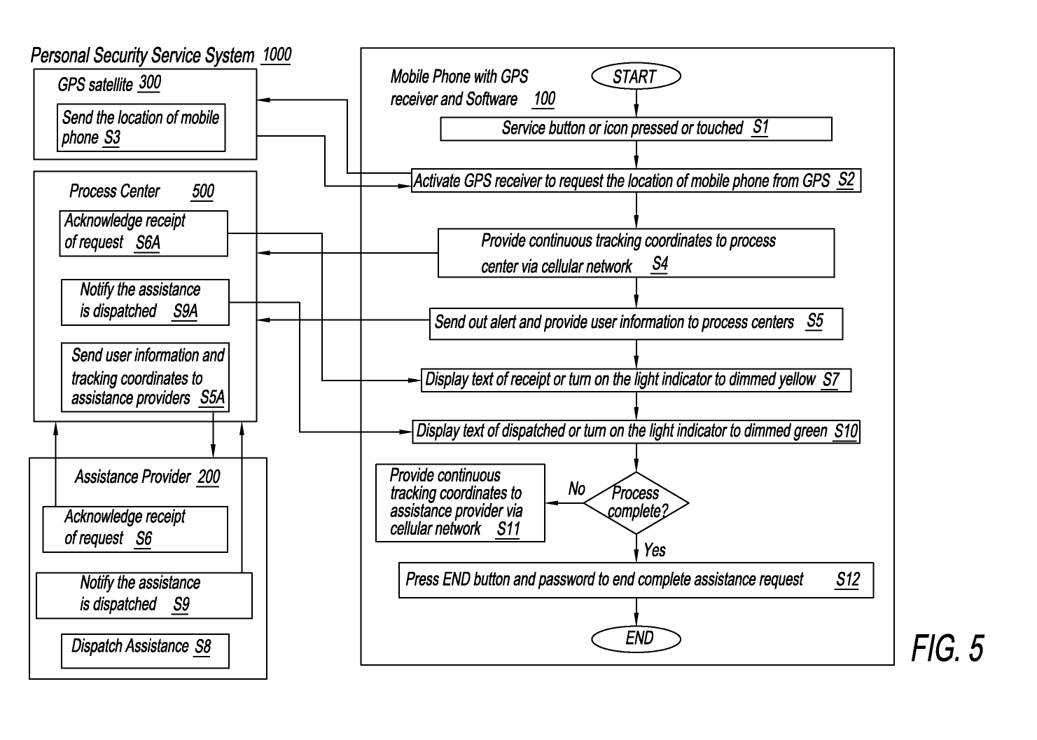

In the aforementioned embodiments, in order to streamline the service system (i.e. reducing the unnecessary steps); software is programmed to have the interface allowing the user to directly interact with the assistance providers. In another embodiment (FIG. 4), the personal security service may have a center that monitors (step S13) but does not involves the activities of the assistance providers; so the system is still streamlined and efficient but it offers additional support and comfort to the user in panic. In another embodiment, the personal security system may have a process center that coordinates the dispatch of assistance providers as disclosed in FIG. 5. In this embodiment, the personal security process center receives the alert and the mobile phone's coordinates calculated by the GPS receiver.

The personal security process center then forward the received alert and mobile phone coordinates to the assistance provider at step SSA. The assistance provider responds to the personal security process center when they receive alert and coordinates (step S6) and notify that the center (step S9) after they dispatch the assistance (step S8). The personal security process center then forwards the response to the user (step S6A and S9A). It's obvious that it takes longer to process the request and send in dispatch because the process flow involves more steps and parties in this embodiment.

Other types of communication technologies known in the art in addition to mobile phone may be used. For example, using a land lines connected phone a customer dials a specific number that connects the customer through the provider to the personal security service, and the GPS service does not have to be activated. Other types of tracking and location systems known in the art in addition to GPS may be used.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A personal security system comprising:
a. a location and continuous tracking system to locate and continuously track the current position of mobile devices;
b. a software program that displays assistance provider icons on the mobile device's touch screen for the user to select the different assistance by touching the icon;
c. the software program can utilize the button on the mobile device such as having the fast dial or side button programmed to request different services;
d. the software performs several actions when the assistance icon or button on the mobile device is pushed including:
1) activating location and tracking of the mobile device;
2) sending an alert to the assistance provider with the current position via SMS or e-mail;
3) providing personal information about the caller to the assistance providers according to the type of assistance needed; and
e. a personal security service plan that is in agreement with the assistance providers to dispatch immediate assistance without asking further questions.

2. The personal security system of claim 1, wherein the location and tracking system is Global Positioning System (GPS).

3. The personal security system of claim 1, wherein the mobile device is a mobile phone.

4. The personal security system of claim 1 may further comprise a process center which monitors the process or assist in the dispatch if necessary.

5. The personal security system of claim 1, wherein the software can be programmed to send back responses in text format as a confirmation to the requester that their request for assistance has been received and the assistance has been dispatched.

6. The personal security system of claim 5, wherein the response may be shown through an indicator light to acknowledge that the request is received and the dispatch is on the way.

7. The personal security system of claim 1, wherein the software program has icons including homeland security, police station, medical center, fire department, roadside service, taxi service.

8. The personal security system of claim 1, wherein said personal security service plan further include overseas service, which will be provided through the cellular network roaming services for the mobile devices.

9. A method for providing a personal security service comprising:
a. providing a location and continuous tracking to locate and continuously track the current position of mobile devices;
b. providing a software program that displays assistance provider icons on the mobile device's touch screen for the user to select the different assistance by touching the icon;
c. the software program can utilize the button on the mobile device such as having the fast dial or side button programmed to request different services;
d. the software performs several actions when the assistance icon or button on the mobile device is pushed including:
1) activating location and tracking of the mobile device;
2) sending an alert to the assistance provider with the current position via SMS or e-mail;
3) providing personal information about the caller to the assistance providers according to the type of assistance needed; and
e. providing a personal security service plan that is in agreement with the assistance providers to dispatch immediate assistance without asking further questions.

10. The personal security system of claim 9, wherein the location and tracking system is Global Positioning System (GPS).

11. The personal security system of claim 9, wherein the mobile device is a mobile phone.

12. The personal security system of claim 9 may further comprise a process center which monitors the process or assist in the dispatch if necessary.

13. The personal security system of claim 9, wherein the software can be programmed to send back responses in text format as a confirmation to the requester that their request for assistance has been received and the assistance has been dispatched.

14. The personal security system of claim 13, wherein the response may be shown through a light indicator to acknowledge that the request is received and the dispatch is on the way.

15. The personal security system of claim 9, wherein the software program has icons including homeland security, police station, medical center, fire department, roadside service, taxi service.

16. A method for deploying a personal security system comprises providing a computer infrastructure being operable to maintain customer and assistance provider database, software programs, monitoring and tracking personal security service process; and establishing rapports with assistance providers through business arrangement or official authorization to ensure immediate assistance dispatch.

17. The method for deploying a personal security system of claim 16 further comprises setting up a process center if necessary.
